(19) United States
(12) Patent Application Publication
(10) Pub. No.: US 2019/0088276 A1
(43) Pub. Date: Mar. 21, 2019

(54) A READER STRUCTURE

(71) Applicant: Agency for Science, Technology and Research, Singapore (SG)

(72) Inventors: Chun Lian ONG, Singapore (SG); Zhimin YUAN, Singapore (SG); Shiming ANG, Singapore (SG)

(21) Appl. No.: 16/081,294

(22) PCT Filed: Feb. 28, 2017
(86) PCT No.: PCT/SG2017/050091

§ 371 Date: Aug. 30, 2018

(30) Foreign Application Priority Data
Mar. 2, 2016 (SG) 10201601586Y

(51) Int. Cl. G11B 5/39; G11B 5/127; G11B 5/31

(52) U.S. Cl. CPC G11B 5/3932; G11B 5/3146; G11B 5/3948; G11B 5/1278

(57) ABSTRACT

A reader structure, a method of biasing a free layer of a reader structure, and a read head are provided, the reader structure comprises a free layer having a reader edge for interacting with and being proximal to a magnetic media; a first magnetic bias member and a second magnetic bias member each provided adjacent to the free layer, the first and second magnetic bias members being configured to have a first magnetisation direction which is substantially parallel to the reader edge; an additional bias member disposed adjacent to the free layer, the additional bias member further being located proximal to at least one of the first magnetic bias member and the second magnetic bias member, and the additional bias member being configured to have a magnetisation direction that is substantially orthogonal to the first magnetisation direction.

### TECHNICAL FIELD

The present disclosure relates broadly to a reader structure, and to magnetic biasing of a free layer of a reader structure for enhancing the reader structure signal output.

### BACKGROUND

Magnetoresistive sensors or heads are commonly used to read information from magnetic storage devices such as disk drives, which utilise rotating magnetic disks to record/store data in magnetic form on concentric, radially spaced tracks on the disk surfaces.

Typically, a magnetoresistive sensor has a reader structure which comprises a free layer, which is a layer of ferromagnetic material having a low coercivity. The magnetisation of the free layer is not fixed and is free to rotate in response to a magnetic field being sensed, e.g. magnetic field from the magnetic disk.

Reading of magnetically recorded information is performed by sensing changes in the direction of magnetisation in the free layer, which in turn result in changes in the electrical resistivity in the free layer. In general, it is desirable for the free layer to be in a single magnetic domain state, that is, for the magnetisation of the free layer to be biased substantially uniformly throughout the free layer. To ensure that the free layer remains in a single magnetic domain, current reader structures typically include at least one hard bias component arranged in-plane with the free layer to bias magnetisation of the free layer.

However, development in data storage technology has led to an increase in areal density, which is a measure of the quantity of recording bits that can be stored on a given length of track, area of surface, or in a given volume of a storage device. In general, the higher the areal density, the greater the volume of data that can be stored in the same physical space.

It has been recognised that in achieving higher areal density, the recording bit size gets smaller. Consequently, the signal to noise ratio of a reader output may deteriorate as there are limitations to current methods of enhancing signal strength from the magnetic media. Such limitations in the reader structure also make it difficult to increase the storage density of magnetic storage devices.

In view of the above, there is a need to develop a reader structure and a method of biasing a free layer of a reader structure to address at least one of the above problems.

### SUMMARY

In accordance with a first aspect of the present disclosure, there is provided a reader structure comprising, a free layer having a reader edge for interacting with and being proximal to a magnetic media; a first magnetic bias member and a second magnetic bias member each provided adjacent to the free layer, the first and second magnetic bias members being configured to have a first magnetisation direction which is substantially parallel to the reader edge; an additional bias member disposed adjacent to the free layer, the additional bias member further being located proximal to at least one of the first magnetic bias member and the second magnetic bias member, and the additional bias member being configured to have a magnetisation direction that is substantially orthogonal to the first magnetisation direction.

The reader structure may further comprise the additional bias member being in the form of a dual-polarity bias member that comprises at least a third magnetic bias component and a fourth magnetic bias component, the third magnetic bias component being located proximal to the first magnetic bias member and the fourth magnetic bias component being located proximal to the second magnetic bias member; wherein the third and fourth magnetic bias components are configured to have alternate magnetisation directions, and further wherein the alternate magnetisation directions are substantially orthogonal to the first magnetisation direction.

The additional bias member may be disposed adjacent to the free layer at an opposite edge to the reader edge.

The additional bias member may be disposed adjacent to the free layer as a layer of the reader structure and said layer being in a plane passing through the free layer and the first magnetic bias member and the second magnetic bias member.

The third and the fourth magnetic bias components may be provided adjacent to each other.

The magnetisation direction of the first magnetic bias member may be orthogonally aligned to the magnetisation direction of the third magnetic bias component.

The magnetisation direction of the second magnetic bias member may be orthogonally aligned to the magnetisation direction of the fourth magnetic bias component.

In accordance with a second aspect of the present disclosure, there is provided a method of biasing a free layer of a reader structure that comprises a reader edge for interacting with and being proximal to a magnetic media, the method comprising, providing a first magnetic bias member and a second magnetic bias member each adjacent to the free layer; biasing a first magnetisation direction which is substantially parallel to the reader edge; providing an additional bias member disposed adjacent to the free layer, the additional bias member being located proximal to at least one of the first magnetic bias member and the second magnetic bias member; and biasing the additional bias member to have a magnetisation direction that is substantially orthogonal to the first magnetisation direction.

The additional bias member may be provided in the form of a dual-polarity bias member that comprises at least a third magnetic bias component and a fourth magnetic bias component, the third magnetic bias component being located proximal to the first magnetic bias member and the fourth magnetic bias component being located proximal to the second magnetic bias member; and wherein the third and fourth magnetic bias components are configured to have alternate magnetisation directions, and further wherein the alternate magnetisation directions are substantially orthogonal to the first magnetisation direction.

The additional bias member may be disposed adjacent to the free layer at an opposite edge to the reader edge.

The additional bias member may be disposed adjacent to the free layer as a layer of the reader structure and said layer being in a plane passing through the free layer and the first magnetic bias member and the second magnetic bias member.

The magnetisation direction of the first magnetic bias member may be orthogonally aligned to the magnetisation direction of the third magnetic bias component.

The magnetisation direction of the second magnetic bias member may be orthogonally aligned to the magnetisation direction of the fourth magnetic bias component.

The third and fourth magnetic bias components may be located adjacent to each other.

In accordance with a third aspect of the present disclosure, there is provided a read head, the read head comprising, a reader structure for reading magnetically recorded information, the reader structure comprising, a free layer having a reader edge for interacting with and being proximal to a magnetic media; a first magnetic bias member and a second magnetic bias member each provided adjacent to the free layer, the first and second magnetic bias members being configured to have a first magnetisation direction which is substantially parallel to the reader edge; an additional bias member disposed adjacent to the free layer, the additional bias member further being located proximal to at least one of the first magnetic bias member and the second magnetic bias member, and the additional bias member configured to have a magnetisation direction that is substantially orthogonal to the first magnetisation direction.

The read head may comprise the additional bias member being in the form of a dual-polarity bias member that comprises at least a third magnetic bias component and a fourth magnetic bias component, the third magnetic bias component being located proximal to the first magnetic bias member and the fourth magnetic bias component being located proximal to the second magnetic bias member; wherein the third and fourth magnetic bias components are configured to have alternate magnetisation directions, and further wherein the alternate magnetisation directions are substantially orthogonal to the first magnetisation direction.

### BRIEF DESCRIPTION OF THE DRAWINGS

Exemplary embodiments of the invention will be better understood and readily apparent to one of ordinary skill in the art from the following written description, by way of example only, and in conjunction with the drawings, in which:

FIG. 1 is a schematic drawing showing the bottom view of a reader structure in an exemplary embodiment.

FIG. 2 is a schematic side view drawing of a reader structure in an exemplary embodiment.

FIG. 3 is a schematic drawing of a reader structure in an exemplary embodiment.

FIG. 4 is a schematic side-view drawing of a reader structure in an exemplary embodiment.

FIG. 5A is a schematic top view drawing of an experimental setup.

FIG. 5B is a schematic side view drawing of the experimental setup.

FIG. 6A is a diagram showing the magnetic field distribution in the read sensor interacting with P-N (DC+/DC−) tracks.

FIG. 6B is a diagram showing the magnetic field distribution in the read sensor interacting with N-P (DC−/DC+) tracks.

FIG. 7A shows a cross-track profile of a reader output signal obtained under experimental conditions for an AC erasure in second layer case.

FIG. 7B shows a cross-track profile of a reader output signal obtained under experimental conditions for a 30 MHz single track in second layer.

FIG. 7C shows a cross-track profile of a reader output signal obtained under experimental conditions for a 30 MHz single track in second layer with a filter applied.

FIG. 8 shows a series of graphs comparing the on-track sensor output amplitude under different free layer bias conditions.

FIG. 9 is a graph showing variations in reader signal track average amplitude (TAA) with respect to the hard bias (HB) field strength of the dual-polarity bias member.

FIG. 10 is a graph comparing the total SNR (signal to noise ratio) to the noise level using the dual magnetic layer media of FIG. 5.

FIG. 11A is a schematic side-view drawing of a reader structure in an exemplary embodiment.

FIG. 11B is a schematic side-view drawing of a reader structure in an exemplary embodiment.

FIG. 12 is a schematic flowchart for illustrating a method of biasing a free layer of a reader structure that comprises a reader edge for interacting with and being proximal to a magnetic media in an exemplary embodiment.

### DETAILED DESCRIPTION

Exemplary, non-limiting embodiments may provide a reader structure for reading magnetically recorded information from a magnetic media, and a method of biasing a free layer of a reader structure for enhancing the signal output. The reader structure may be incorporated into a read head or a read sensor. The reader structure may also amplify readback amplitude.

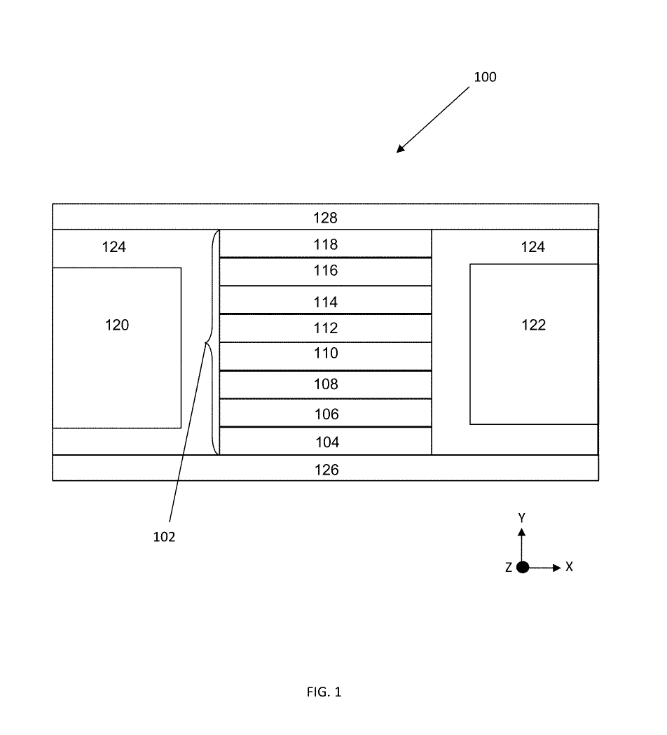

FIG. 1 is a schematic drawing showing the bottom view of a reader structure 100 in an exemplary embodiment. The reader structure 100 is made up of a stacked layer 102 comprising a seed layer 104, an antiferromagnetic (AFM) layer 106 formed over the seed layer 104, a pinned layer 108 formed over the AFM layer 106, an anti-parallel (AP) coupling layer 110 formed over the pinned layer 108, a reference layer 112 formed over the AP-coupling layer 110, a spacer layer 114 formed over the reference layer 112, a free layer 116 formed over the spacer layer 114, and a cap layer 118 formed over the free layer 116.

The reader structure 100 also comprises a first magnetic bias member 120 and a second magnetic bias member 122 each located adjacent to respective lateral edges of the stacked layer 102 and separated from the stacked layer 102 by an insulator 124. A first shield layer 126 and a second shield layer 128 are provided adjacent to and over the seed layer 104 and the cap layer 118 respectively, at opposite ends of the reader structure 100 to shield/cover the stacked layer 102, the first magnetic bias component 120 and the second magnetic bias component 122.

In the exemplary embodiment, electrical resistivity changes in the free layer 116 allow the reader structure 100 to detect magnetically recorded information. The free layer 116 is made of ferromagnetic material such as, but not limited to, Ni, Fe, Co, NiFe, CoFe, NiCoFe and combinations thereof which results in the free layer having relatively low coercivity. Consequently, the magnetisation/magnetic moments are free to rotate in response to changes in the magnetic field being sensed, and the magnetisation changes in turn change the resistance to a current flowing through the reader structure 100. Data on a magnetic media can be read by detecting changes in the current flow as the reader structure 100 passes over the magnetic media.

It is desirable for the magnetisation of the free layer 116 to be oriented in a single magnetic domain state. As such, magnetic bias members are provided and functions to maintain the free layer in a single magnetic domain state. In FIG. 1, the first magnetic bias member 120 and a second magnetic bias member 122 are configured to provide magnetisation in the X-direction, which is substantially parallel to the free layer 116. The first magnetic bias member 120 and a second magnetic bias member 122 can be made from material such as, but not limited to, an alloy containing Co, Pt and Cr e.g. CoPt, Co₈₀Pt₁₂Cr₈, CoCrPtTa, CoCrPtB, CrPt, FePt. These material have relatively high coercivity and are selected to provide a sufficiently high bias to the free layer 116.

In the exemplary embodiment, one or more additional bias structures/members are provided to stabilize the magnetisation of the free layer 116. For example, additional bias structures may be provided adjacent to the free layer 116 with both the free layer and the additional bias structures in the X-Z plane, i.e. stacked into the paper. Alternatively, the additional bias structures may be provided adjacent to the free layer 116 with both the free layer and the additional bias structures extending within the X-Y plane, said additional bias structures disposed within the stacked layer 102.

In the exemplary embodiment, the magnetisation direction(s) of the additional bias structure(s) may be configured to be substantially orthogonal/perpendicular to the magnetisation direction of the first magnetic bias member 120 and the second magnetic bias member 122, i.e. orthogonal to the X-axis. In addition, the magnetisation direction(s) of the additional bias structure(s) may be configured to be orthogonally aligned with the magnetisation direction of the first magnetic bias member 120 or the magnetisation direction of the second magnetic bias member 122.

For example, when the magnetisation direction of the additional bias structure is orthogonally aligned with the magnetisation direction of the first magnetic bias member 120, the magnetisation points from the North Pole of the first magnetic bias member 120 to the South Pole of the additional bias structure, i.e. at the side proximal to the free layer 116. In a scenario with a single additional bias structure, the additional bias structure may be located proximal to the first magnetic bias member 120 as compared to the second magnetic bias member 122. In other embodiments, the first magnetic bias member 120 and the additional bias structure may also be orthogonally aligned when the polarity of the first magnetic bias member 120 and additional bias structure are reversed.

Alternatively, when the magnetisation direction of the additional bias structure is orthogonally aligned with the magnetisation direction of the second magnetic bias member 122, the magnetisation points from the North Pole of the additional bias structure, i.e. at the side proximal to the free layer 116, to the South Pole of the second magnetic bias member 122. In a scenario with a single additional bias structure, the additional bias structure may be located proximal to the second magnetic bias member 122 as compared to the first magnetic bias member 120. In other embodiments, the second magnetic bias member 122 and the additional bias structure may also be orthogonally aligned when the polarity of the second magnetic bias member 122 and additional bias structure are reversed.

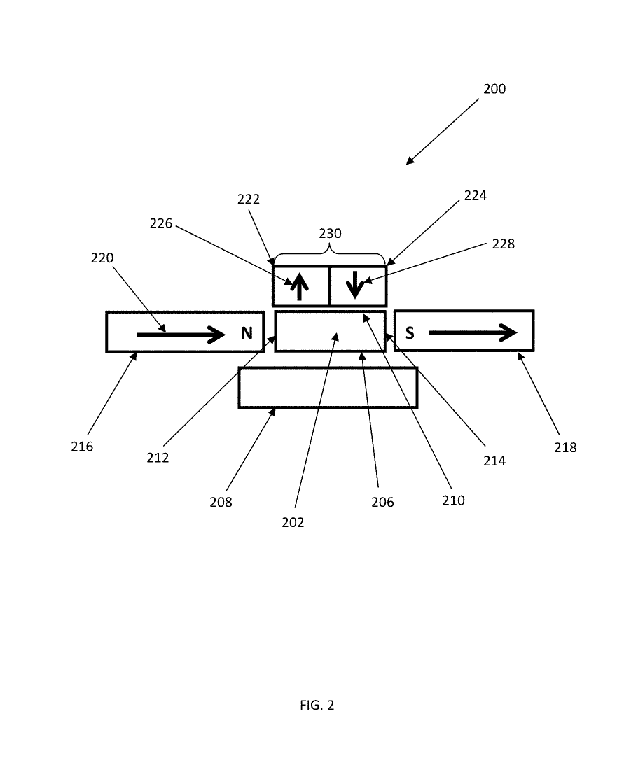

FIGS. 2, 3 and 4 are exemplary embodiments showing two additional bias structures/members incorporated as a dual-polarity bias member to enhance signal output from a reader structure.

FIG. 2 is a schematic side-view drawing of a reader structure 200 in an exemplary embodiment. The reader structure 200 may be used in a read sensor or read head for reading magnetically recorded information. The reader structure 200 comprises a free layer 202 (compare 116 of FIG. 1) having a front reader edge 206 arranged to be proximal to a data track 208 of a magnetic media and a back edge 210 located opposite the front reader edge 206, a first lateral edge 212 and a second lateral edge 214 located opposite each other, each lateral edge extending from the front reader edge 206 to the back edge 210. The reader edge 206 also allows the free layer 202 to be capable of interacting with a magnetic media proximal to the reader edge 206. For ease of illustration, other components in the reader structure 200, e.g. shield layer, pinned layer, AFM layer etc. are not shown in FIG. 2.

The reader structure 200 further comprises a first magnetic bias member 216 and a second magnetic bias member 218 provided adjacent to the first lateral edge 212 and second lateral edge 214 of the free layer 202 respectively. The first magnetic bias member 216 and second magnetic bias member 218 are configured to have a first magnetisation direction 220 which is substantially parallel to the reader edge 206 of the free layer 202. The first magnetisation direction 220 points from the North (N) Pole of the first magnetic bias member 216 to the South (S) Pole of the second magnetic bias member 218.

A dual-polarity bias member 230 comprising a third magnetic bias component 222 and a fourth magnetic bias component 224 is disposed adjacent to the back edge 210 of the free layer 202. The third magnetic bias component 222 and the fourth magnetic bias component 224 are adjacent to each other. The third magnetic bias component 222 is situated proximal to the first magnetic bias member 216 and the fourth magnetic bias component 224 is situated proximal to the second magnetic bias member 218. The interface between the third magnetic bias component 222 and fourth magnetic bias component 224 is disposed substantially at the mid-point position of the free layer 202. The dual-polarity bias member 230 functions to enhance signal output from the reader structure 200.

In the exemplary embodiment, the magnetisation direction 226 of the third magnetic bias component 222 is substantially opposite to the magnetisation direction 228 of the fourth magnetic bias component 224, i.e. the magnetic bias components having alternate magnetisation directions. In addition, the magnetisation directions of the third and fourth magnetic bias components 222 and 224 are configured to be substantially orthogonal/perpendicular to the first magnetisation direction 220. The individual magnetisation orientations of the third and fourth magnetic bias components 222 and 224 also depend on the magnetisation directions of the first and second magnetic bias members 216 and 218.

As shown in FIG. 2, the magnetisation direction of the third magnetic bias component 222 is configured to be orthogonally aligned with the magnetisation direction of the first magnetic bias member 216. That is, the magnetisation points from the North Pole of the first magnetic bias member 216 to the South Pole of the third magnetic bias component 222, i.e. at the side proximal to the free layer 202. This is illustrated in FIG. 2.

The magnetisation direction of the fourth magnetic bias component 224 is configured to be orthogonally aligned with the magnetisation direction of the second magnetic bias member 218. That is, the magnetisation points from the North Pole of the fourth magnetic bias component 224, i.e. at the side proximal to the free layer 202, to the South Pole of the second magnetic bias member 218. This is illustrated in FIG. 2.

The magnetisation directions 226 and 228 of the third and fourth magnetic bias components 222 and 224 are substantially orthogonal to the surface of the data track 208.

In the exemplary embodiment, the free layer 202 has a thickness from about 2 nm to about 8 nm. The first magnetic bias member 216 and second magnetic bias member 218 has a thickness from about 10 nm to about 30 nm. The dual-polarity bias member has a thickness from about 10 nm to about 30 nm. The magnetic field strength of the first magnetic bias member 216 and the second magnetic bias member 218 is each about 10 to 200 Oe. The magnetic field strength of the third magnetic bias component 222 and the fourth magnetic bias component 224 is each about 10 to 200 Oe.

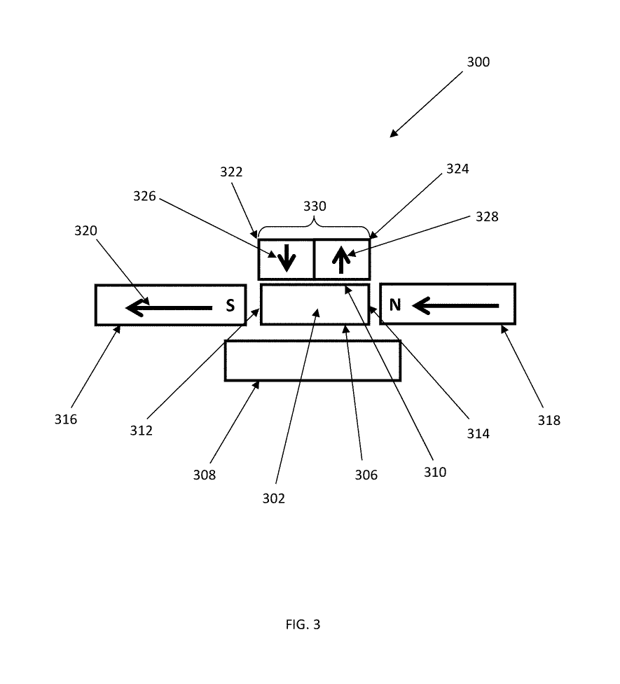

FIG. 3 is a schematic drawing of a reader structure 300 in an exemplary embodiment. The reader structure 300 functions substantially similarly to the reader structure 200 of FIG. 2, except that the directions of magnetisation in the magnetic bias members and dual polarity bias member are reversed. For completeness of illustration, a description of FIG. 3 is provided.

The reader structure 300 comprises a free layer 302 (compare 116 of FIG. 1) having a front reader edge 306 arranged to be proximal to a data track 308 of a magnetic media and a back edge 310 located opposite the front reader edge 306, a first lateral edge 312 and a second lateral edge 314 located opposite each other, each lateral edge extending from the front reader edge 306 to the back edge 310. The reader edge 306 also allows the free layer 302 to be capable of interacting with a magnetic media proximal to the reader edge 306.

The reader structure 300 further comprises a first magnetic bias member 316 and a second magnetic bias member 318 provided adjacent to the first lateral edge 312 and second lateral edge 314 of the free layer 302 respectively. A dual-polarity bias member 330 comprising a third magnetic bias component 322 and a fourth magnetic bias component 324 is disposed adjacent to the back edge 310 of the free layer 302. The third magnetic bias component 322 and the fourth magnetic bias component 324 are adjacent to each other. The third magnetic bias component 322 is located proximal to the first magnetic bias member 316 and the fourth magnetic bias component 324 is located proximal to the second magnetic bias member 318. The interface between the third magnetic bias component 322 and fourth magnetic bias component 324 is disposed substantially at the mid-point position of the free layer 302. The dual-polarity bias member 330 functions to enhance signal output from the reader structure 300.

In the exemplary embodiment, the first magnetic bias component 316 and second magnetic bias component 318 are configured to have a first magnetisation direction 320 which is substantially parallel to the reader edge 306 of the free layer 302 and points in the direction from the second magnetic bias component 318 to the first magnetic bias component 316. That is, the first magnetisation direction 320 points from the North (N) Pole of the second magnetic bias member 318 to the South (S) Pole of the first magnetic bias member 316.

The magnetisation direction 326 of the third magnetic bias component 322 is substantially opposite to the magnetisation direction 328 of the fourth magnetic bias component 324, i.e. the magnetic bias components having alternate magnetisation directions. In addition, the magnetisation directions of the third and fourth magnetic bias components 322 and 324 are configured to be substantially orthogonal to the first magnetisation direction 320. The individual magnetisation orientations of the third and fourth magnetic bias components 322 and 324 also depend on the magnetisation directions of the first and second magnetic bias members 316 and 318.

As shown in FIG. 3, the magnetisation direction of the fourth magnetic bias component 324 is configured to be orthogonally aligned with the magnetisation direction of the second magnetic bias member 318. That is, the magnetisation points from the North Pole of the second magnetic bias member 318 to the South Pole of the fourth magnetic bias component 324, i.e. at the side proximal to the free layer 302. This is illustrated in FIG. 3.

The magnetisation direction of the third magnetic bias component 322 is configured to be orthogonally aligned with the magnetisation direction of the first magnetic bias member 316. That is, the magnetisation points from the North Pole of the third magnetic bias component 322, i.e. at the side proximal to the free layer 302, to the South Pole of the first magnetic bias member 316. This is illustrated in FIG. 3.

The magnetisation directions 326 and 328 of the third and fourth magnetic bias components 322 and 324 are substantially orthogonal to the surface of the data track 308.

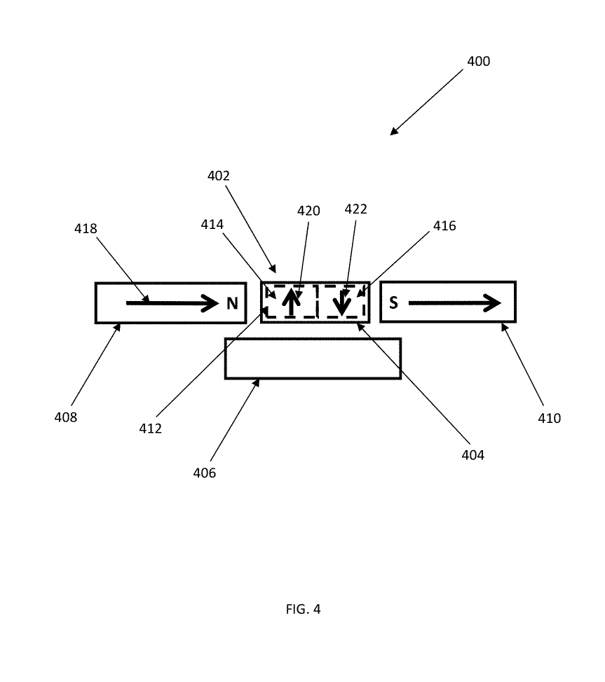

FIG. 4 is a schematic side-view drawing of a reader structure 400 in an exemplary embodiment. The reader structure 400 comprises a free layer 402 with a front reader edge 404 arranged to be proximal to a data track 406, a first magnetic bias member 408 and a second magnetic bias member 410 each provided adjacent to the free layer 402. The reader structure 400 further comprises a dual-polarity bias member 412 comprising a third magnetic bias component 414 and a fourth magnetic bias component 416. The dual-polarity bias member 412 is disposed adjacent to the free layer 402 as a layer of the reader structure 400, the layer being in a plane passing through the free layer 402 and the first magnetic bias member 408 and the second magnetic bias member 410. The interface between the third magnetic bias component 414 and fourth magnetic bias component 416 is disposed substantially at the mid-point position of the free layer 402. For example, the layer may be a new layer disposed between the free layer 116 and the cap layer 118 of FIG. 1.

In the exemplary embodiment, the first magnetic bias member 408 and the second magnetic bias member 410 are configured to have a first magnetisation direction 418 which is substantially parallel to the reader edge 404 of the free layer 402. The first magnetisation direction 418 points from the North Pole of the first magnetic bias member 408 to the South Pole of the second magnetic bias member 410.

The third magnetic bias component 414 is configured to have a magnetisation direction 420 which is substantially opposite to the magnetisation direction 422 of the fourth magnetic bias component 416, i.e. magnetic bias components having alternate magnetisation directions. In addition, the magnetisation directions 420, 422 of the third and fourth magnetic bias components 414, 416 are configured to be substantially orthogonal to the first magnetisation direction 418. The individual magnetisation orientations of the third and fourth magnetic bias components 414 and 416 also depend on the magnetisation directions of the first and second magnetic bias members 408 and 410.

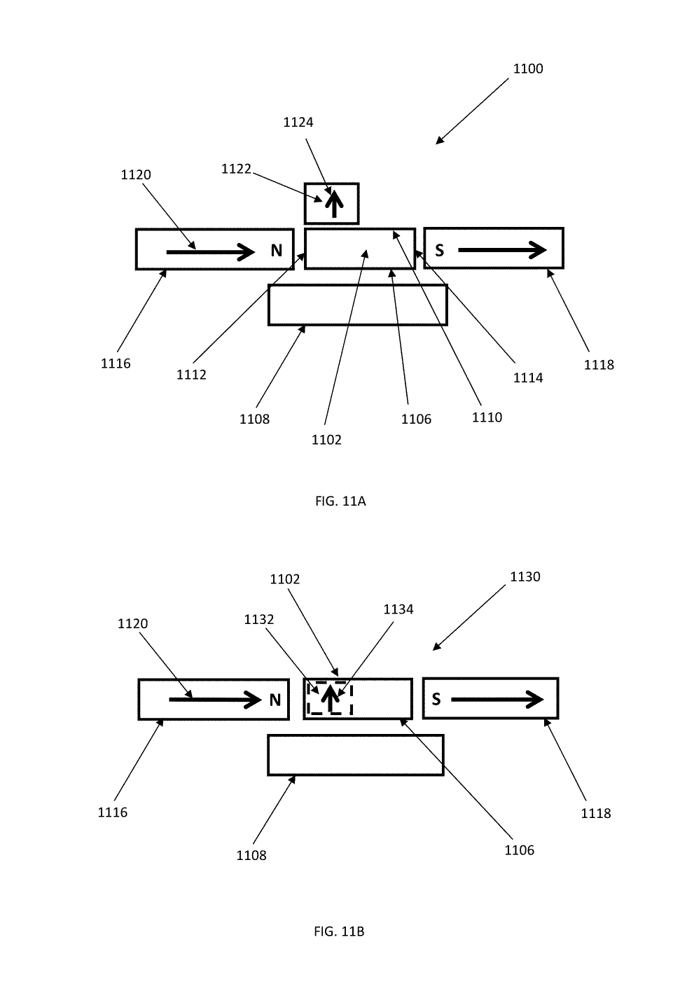

FIGS. 11A and 11B are exemplary embodiments showing one additional bias structure/member incorporated to enhance signal output from a reader structure.

FIG. 11A is a schematic side-view drawing of a reader structure 1100 in an exemplary embodiment. The reader structure 1100 comprises a free layer 1102 (compare 116 of FIG. 1) having a front reader edge 1106 arranged to be proximal to a data track 1108 of a magnetic media and a back edge 1110 located opposite the front reader edge 1106, a first lateral edge 1112 and a second lateral edge 1114 located opposite each other, each lateral edge extending from the front reader edge 1106 to the back edge 1110. The reader edge 1106 also allows the free layer 1102 to be capable of interacting with a magnetic media proximal to the reader edge 1106.

The reader structure 1100 further comprises a first magnetic bias member 1116 and a second magnetic bias member 1118 provided adjacent to the first lateral edge 1112 and second lateral edge 1114 of the free layer 1102 respectively. The first magnetic bias member 1116 and second magnetic bias member 1118 are configured to have a first magnetisation direction 1120 which is substantially parallel to the reader edge 1106 of the free layer 1102. The first magnetisation direction 1120 points from the North (N) Pole of the first magnetic bias member 1116 to the South (S) Pole of the second magnetic bias member 1118.

An additional bias member in the form of a magnetic bias component 1122 is disposed adjacent to the back edge 1110 of the free layer 1102. The magnetic bias component 1122 is located proximal to the first magnetic bias member 1116 as compared to the second magnetic bias member 1118. The magnetic bias component 1122 functions to enhance signal output from the reader structure 1100. In the exemplary embodiment, the magnetic bias component 1122 is configured to have a magnetisation direction 1124 that is substantially orthogonal to the first magnetisation direction 1120.

As shown in FIG. 11A, the magnetisation direction 1124 of the magnetic bias component 1122 is configured to be orthogonally aligned with the magnetisation direction of the first magnetic bias member 1116. That is, the magnetisation points from the North Pole of the first magnetic bias member 1116 to the South Pole of the magnetic bias component 1122, i.e. at the side proximal to the free layer 1102. This is illustrated in FIG. 11A.

FIG. 11B is a schematic side-view drawing of a reader structure 1130 in an exemplary embodiment. The reader structure 1130 is constructed substantially similarly to the reader structure 1100 of FIG. 11A in terms of the free layer 1102, data track 1108, first magnetic bias member 1116 and second magnetic bias member 1118. For ease of reference, the same reference numerals are used for components having similar construction.

In FIG. 11B, the reader structure 1130 comprises a free layer 1102 with a front reader edge 1106 arranged to be proximal to a data track 1108, a first magnetic bias member 1116 and a second magnetic bias member 1118 each provided adjacent to the free layer 1102. The reader structure 1130 further comprises an additional magnetic bias component in the form of a magnetic bias component 1132. The magnetic bias component is disposed adjacent to the free layer 1102 as a layer of the reader structure 1130, the layer being in a plane passing through the free layer 1102 and the first magnetic bias member 1116 and the second magnetic bias member 1118. For example, the layer may be a new layer disposed between the free layer 116 and the cap layer 118 of FIG. 1. The magnetic bias component 1132 is further located proximal to the first magnetic bias member 1116 as compared to the second magnetic bias member 1118.

In the exemplary embodiment, the first magnetic bias member 1116 and the second magnetic bias member 1118 are configured to have a first magnetisation direction 1120 which is substantially parallel to the reader edge 1106 of the free layer 1102. The first magnetisation direction 1120 points from the North Pole of the first magnetic bias member 1116 to the South Pole of the second magnetic bias member 1118. The magnetisation direction of the magnetic bias component 1132 is configured to be substantially orthogonal to the first magnetisation direction 1120. This is illustrated in FIG. 11B.

In other embodiments, the magnetisation directions of the magnetic bias members and the magnetic bias component(s) can be reversed accordingly.

In the described exemplary embodiments, the magnetisation polarity/direction of the first and second magnetic bias members is oriented substantially orthogonally to magnetisation direction of the magnetic bias component(s) to create a multi-domain magnetisation reader free layer. Such a structure is capable of amplifying the signal output.

In the exemplary embodiments of FIGS. 11A and 11B, the dimensions and parameters are substantially similar to the dimensions and parameters described with reference to FIG. 2. For example, the magnetic bias component has a thickness of about 10 nm to about 30 nm. Its magnetic field strength is about 10 to 200 Oe. The length of the magnetic bias component may be approximately half of the free layer 1102.

In the described exemplary embodiments, the magnetic bias component(s) can be provided/formed by, for example but are not limited to, techniques such as deposition e.g. sputtering, photolithography, usage of masks etc.

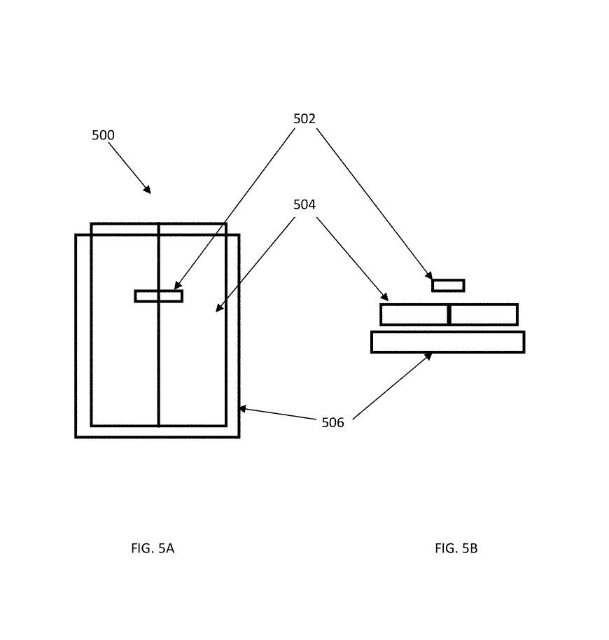

FIG. 5 to FIG. 10 show data obtained from experiments performed using a customised track to demonstrate the enhanced effects of the reader structure as described in various exemplary embodiments.

FIG. 5A is a schematic top view drawing of an experimental setup 500. FIG. 5B is a schematic side view drawing of the experimental setup 500. The experimental setup 500 comprises a read sensor 502 for reading a special or customised dual magnetic layer media made up of a first magnetic layer 504 and a second magnetic layer 506. In the experimental setup 500, a wide writer pole (about 1.5 μm width) is used to write the second magnetic layer 506 with a 30 MHz signal. The written track is shingled erased to prepare a 300 nm track width of 30 MHz signal. A smaller writer pole with a width of about 60 nm is then used to write testing tracks on the first magnetic layer 504 with 1) AC erase, 2) DC+ and DC− tracks (P-N) and 3) DC− and DC+ tracks (N-P).

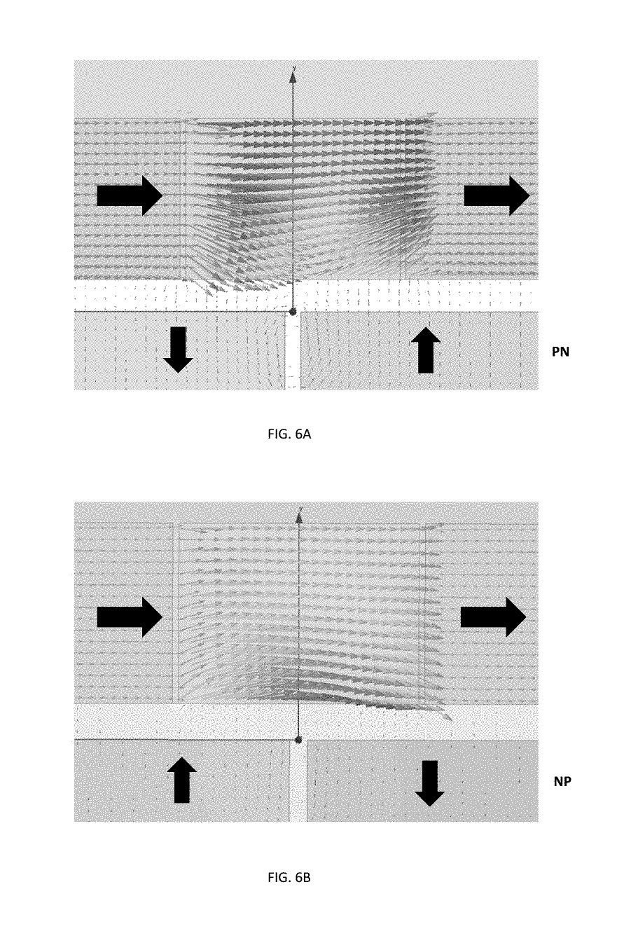

FIG. 6A is a diagram showing the magnetic field distribution in the read sensor interacting with P-N (DC+/DC−) tracks. FIG. 6B is a diagram showing the magnetic field distribution in the read sensor interacting with N-P (DC−/DC+) tracks. An ANSYS simulation is used to model the effect on the magnetic field distribution in the read sensor (Free layer, FL) under the influence of cross track media field. In the modelling, the read sensor is positioned at the centre of the 2 DC tracks. When the North Pole of the hard bias magnet is adjacent to the DC+ track, magnetic field distribution in the free layer is severely deviated (see FIG. 6A). However, when the DC− track is located adjacent to the hard bias North Pole, the magnetic field distribution shows a lesser impact (see FIG. 6B). It is observed that FIG. 6A shows an orthogonally aligned arrangement that can provide an amplified signal readback that may be more resilient to noise. The simulation shows that it is possible to provide an orthogonally aligned dual-polarity bias member (with respect to the single-domain bias members) to obtain a significant signal enhancement, i.e. to replicate a PN case.

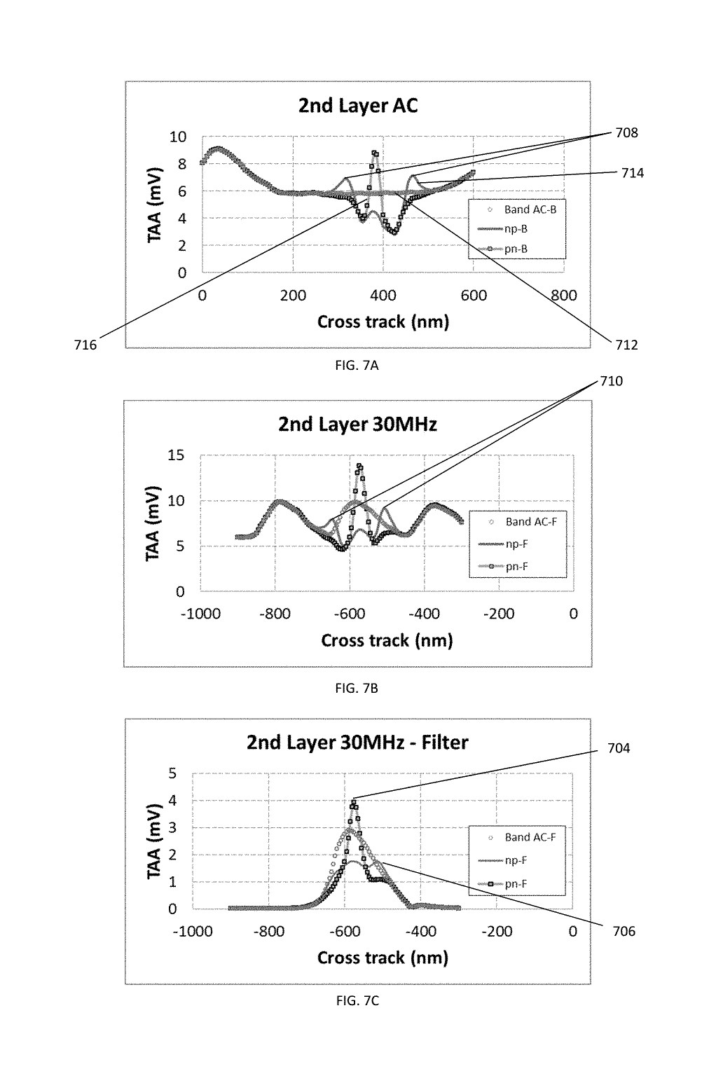

FIG. 7A shows a cross-track profile of a reader output signal obtained under experimental conditions for an AC erasure in second layer case. FIG. 7B shows a cross-track profile of a reader output signal obtained under experimental conditions for a 30 MHz single track in second layer. FIG. 7C shows a cross-track profile of a reader output signal obtained under experimental conditions for a 30 MHz single track in second layer with filter applied. The experimental conditions are as described with reference to FIG. 5. The results for the band AC-B condition is represented by a line 712 created by a series of circles. The results for the np-B condition is represented by a solid line 714. The results for the pn-B condition is represented by a solid line 716 connecting a series of squares. Particular reference is made to FIG. 7C which shows three cross track read sensor outputs of 30 MHz signal after a narrow band pass filter is applied. For this case, when the top layer media is written in a dual track DC+ and DC− (PN) configuration where edges of DC+ and DC− track are positioned at the centre of 30 MHz (bottom layer media), the output signal (30 MHz) is largest (see numeral 704). That is, the sensor output is the highest when the reader position is at the centre of the P-N track. However, the sensor output is observed to be the lowest for inversed track polarity (NP) case (see numeral 706). An amplification effect is observed in the DC+/DC− (PN) configuration. It is also observed that for the np-B case, side peaks are observed in FIG. 7A and FIG. 7B. The presence of these side peaks is akin to having an additional bias structure that has a single magnetisation direction which is orthogonal to the first magnetisation direction. See numerals 708 and 710.

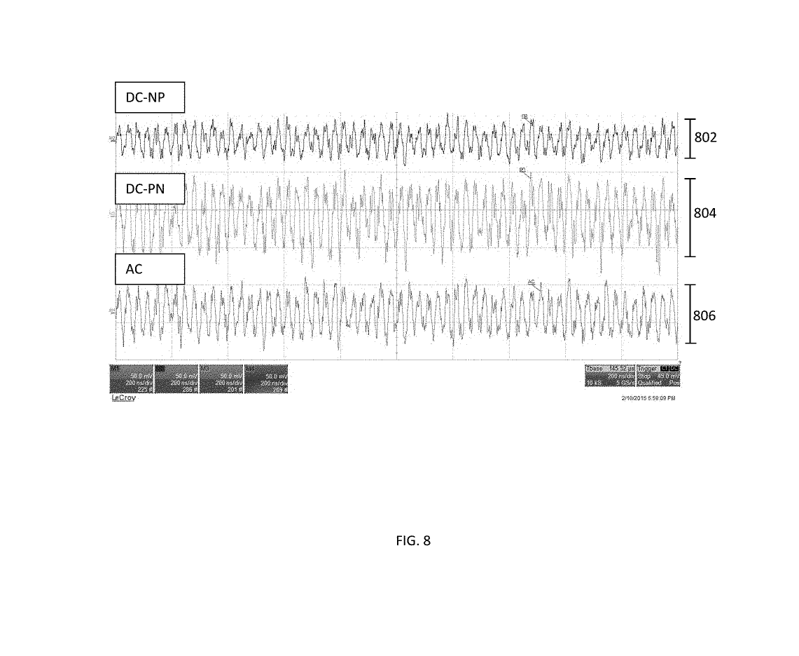

FIG. 8 shows a series of graphs comparing the on-track sensor output amplitude under different free layer bias conditions. As shown in FIG. 8, the time domain signal of sensor outputs at different configurations (DC−NP, DC−PN and AC) are plotted. The amplitudes of the NP case is shown at numeral 802. The amplitudes of the PN case is shown at numeral 804. The amplitudes of the AC case is shown at numeral 806. It is observed that the P-N configuration is shown to have the largest amplitude. The experiment demonstrates that if an additional hard bias field is incorporated in the reader structure design, the signal output could be amplified. Therefore, it is demonstrated that the additional dual-polarity bias member can amplify signal output.

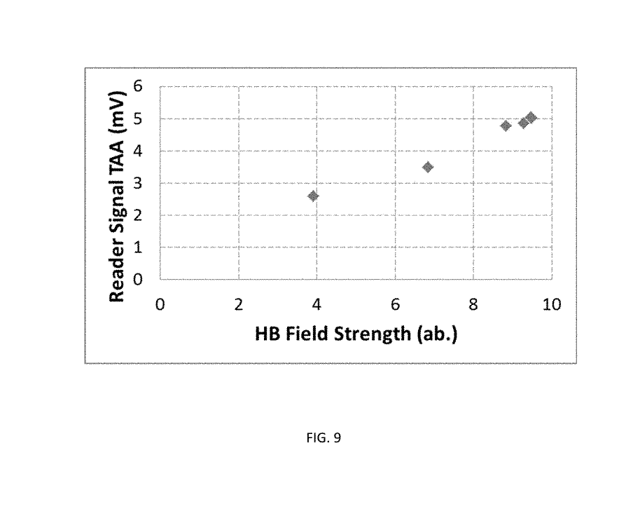

FIG. 9 is a graph showing variations in reader signal track average amplitude (TAA) with respect to the hard bias (HB) field strength of the dual-polarity bias member. The HB field strength of the dual-polarity bias member is denoted by an arbitrary relative value “ab”. As shown, there is a positive correlation between the HB field strength and the reader signal TAA. In general, the larger the additional hard bias field strength, the larger the reader output. The results show that the field strength of the dual-polarity bias member affects the final signal amplification.

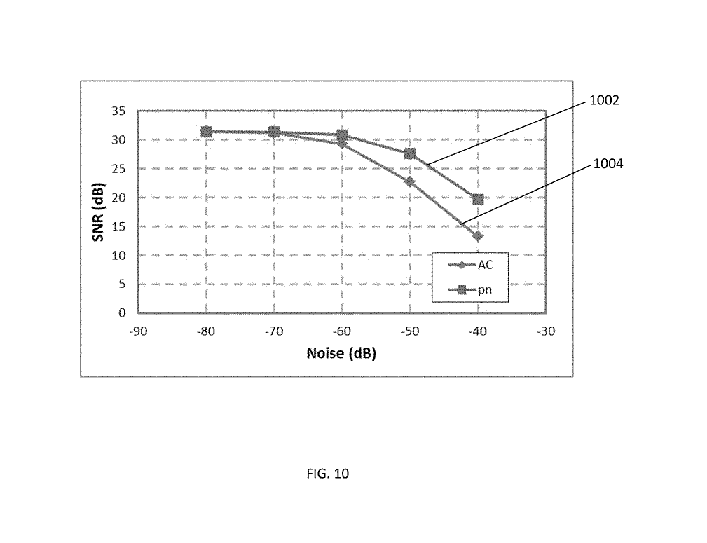

FIG. 10 is a graph comparing the total SNR (signal to noise ratio) to the noise level using the dual magnetic layer media of FIG. 5. As the noise level increases, the SNR of both AC and PN configurations decrease. However, at higher noise levels e.g. −50 to −40 dB, it is observed that the PN configuration (at numeral 1002) is able to maintain a higher SNR as compared to the AC configuration (at numeral 1004).

Table 1 below provides a summary of the average signal, noise and signal-to-noise ratio for the different configurations.

TABLE 1
Measurement of signal, noise and signal-to-noise
ratio for the different configurations

| | | Media Noise floor | Non-repeatable | |
|---|---|---|---|---|
| | Signal (dBm) | (dBm) | noise floor (dBm) | SNR (dB) |
| AC | −22.63 | −54.92 | −73.23 | 32.29 |
| NP | −26.61 | −58.12 | −74.28 | 31.51 |
| PN | −20.00 | −51.46 | −71.70 | 31.46 |

Typically, it is anticipated that adding additional components may increase noise to a system. It has been found, however, that adding a dual-polarity bias member can surprisingly improve and enhance signal readback amplitude. The PN configuration to replicate the dual-polarity bias member is observed to have a 6 dB amplitude increment as compared to the NP case (see first column). It has been surprisingly found that even though there is an additional 3 dB head noise (non-repeatable noise) between the NP and PN cases (see third column), the net signal quality gain, i.e. total sensor signal to noise ratio has a significant net gain of about 3 dB.

For the AC erase case, the amplitude is observed to be larger than the NP case due to the nature of 2 layer magnetic media. When the AC is erasing the first top magnetic layer, the magnetisation of the top layer tends to follow the second bottom layer magnetisation. This explains why the AC erase case has a higher amplitude than the NP case. In addition, the repeatable noise (from the media) for PN and NP case is higher due to track edge transition. The results show that the AC case has less repeatable noise. The inventors recognised that an appropriate sensor output comparison is based on the PN and NP configurations and the results demonstrate that a read sensor configuration based on the PN and NP cases is capable of amplifying the sensor output signal.

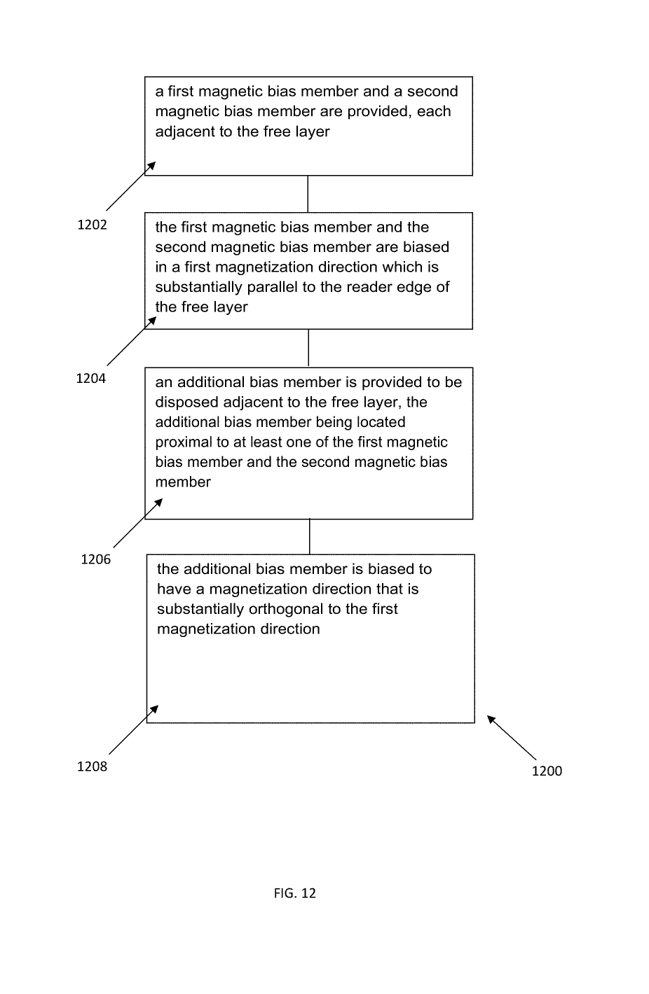

FIG. 12 is a schematic flowchart 1200 for illustrating a method of biasing a free layer of a reader structure that comprises a reader edge for interacting with and being proximal to a magnetic media in an exemplary embodiment. At step 1202, a first magnetic bias member and a second magnetic bias member are provided, each adjacent to the free layer. At step 1204, the first magnetic bias member and the second magnetic bias member are biased in a first magnetisation direction which is substantially parallel to the reader edge of the free layer. At step 1206, an additional bias member is provided to be disposed adjacent to the free layer, the additional bias member being located proximal to at least one of the first magnetic bias member and the second magnetic bias member. At step 1208, the additional bias member is biased to have a magnetisation direction that is substantially orthogonal to the first magnetisation direction.

In the exemplary embodiments described herein, a reader structure suitable for amplifying the signal output is provided. Additional magnetic bias members in the form of a dual-polarity bias member is added to a reader structure having at least one other magnetic bias member. The magnetisation directions of at least two bias components of the dual-polarity bias member are oriented substantially orthogonal to the other magnetic bias members to create multi domain magnetisation on the reader free layer. Such a structure is surprisingly found to be capable of amplifying the sensor output.

Experiments for proof of concept have been conducted akin to the reader structure described in the exemplary embodiments and the benefits of the reader structure are demonstrated by the experimental data. In achieving higher areal densities in magnetic recording media, the recording bit size becomes smaller and hence signal to noise ratio of a reader output may deteriorate. The reader structure in the exemplary embodiments described herein can be implemented in a read head or sensor, and is capable of providing signal enhancement with improved signal to noise ratio, thus allowing the read heads to read information from magnetic disk with an increased areal density. The reader structure in the exemplary embodiments is capable of meeting the demands of reading information from magnetic disk with an increased areal density, while providing improved signal to noise ratio of an acceptable level.

The terms “coupled” or “connected” as used in this description are intended to cover both directly connected or connected through one or more intermediate means, unless otherwise stated.

Further, unless specifically stated otherwise, and would ordinarily be apparent from the following, a person skilled in the art will appreciate that throughout the present specification, discussions utilizing terms such as “scanning”, “calculating”, “determining”, “replacing”, “generating”, “initializing”, “outputting”, and the like, refer to action and processes of an instructing processor/computer system, or similar electronic circuit/device/component, that manipulates/processes and transforms data represented as physical quantities within the described system into other data similarly represented as physical quantities within the system or other information storage, transmission or display devices etc.

Additionally, when describing some embodiments, the disclosure may have disclosed a method and/or process as a particular sequence of steps. However, unless otherwise required, it will be appreciated the method or process should not be limited to the particular sequence of steps disclosed. Other sequences of steps may be possible. The particular order of the steps disclosed herein should not be construed as undue limitations. Unless otherwise required, a method and/or process disclosed herein should not be limited to the steps being carried out in the order written. The sequence of steps may be varied and still remain within the scope of the disclosure.

Further, in the description herein, the word “substantially” whenever used is understood to include, but not restricted to, “entirely” or “completely” and the like. In addition, terms such as “comprising”, “comprise”, and the like whenever used, are intended to be non-restricting descriptive language in that they broadly include elements/components recited after such terms, in addition to other components not explicitly recited. Further, terms such as “about”, “approximately” and the like whenever used, typically means a reasonable variation, for example a variation of +/−5% of the disclosed value, or a variance of 4% of the disclosed value, or a variance of 3% of the disclosed value, a variance of 2% of the disclosed value or a variance of 1% of the disclosed value.

Furthermore, in the description herein, certain values may be disclosed in a range. The values showing the end points of a range are intended to illustrate a preferred range. Whenever a range has been described, it is intended that the range covers and teaches all possible sub-ranges as well as individual numerical values within that range. That is, the end points of a range should not be interpreted as inflexible limitations. For example, a description of a range of 1% to 5% is intended to have specifically disclosed sub-ranges 1% to 2%, 1% to 3%, 1% to 4%, 2% to 3% etc., as well as individually, values within that range such as 1%, 2%, 3%, 4% and 5%. The intention of the above specific disclosure is applicable to any depth/breadth of a range.

In the described exemplary embodiments, it is appreciated that the reader structure can be implemented in a read sensor or read head. It is also appreciated that the reader structure is compatible with read sensors which operate based on different magnetoresistive effects, e.g. anisotropic magnetoresistance (AMR), magnetic tunnel junctions, giant magnetoresistance (GMR), tunnel magnetoresistance (TMR), and extraordinary magnetoresistance (EMR).

In the described exemplary embodiments, the magnetisation directions of the magnetic bias members and dual-polarity bias member are described to be substantially parallel to the plane surface of the paper. However, it is appreciated that the magnetisation directions are not limited as such and at least one of the magnetisation directions can be directed substantially perpendicular to the plane surface of the paper while still maintaining the orthogonal relationship to the other magnetisation direction.

In the described exemplary embodiments, although it is described that the additional bias structure/member has one bias component with an orthogonally aligned magnetisation or that the dual-polarity bias member has at least two bias components with alternate magnetisation, the exemplary embodiments are not limited as such and may include more than two magnetic bias components with alternate magnetisation.

In the described exemplary embodiments, although it is described that the dual-polarity bias member is orthogonally aligned to the other bias members, the embodiments are not limited as such. That is, for example with reference to FIG. 2, it may be provided that the magnetisation directions of the third and fourth bias components to be reversed while maintaining the magnetisation direction of the first and second bias members.

It will be appreciated by a person skilled in the art that other variations and/or modifications may be made to the specific embodiments without departing from the scope of the invention as broadly described. The present embodiments are, therefore, to be considered in all respects to be illustrative and not restrictive.

1. A reader structure comprising,
a free layer having a reader edge for interacting with and being proximal to a magnetic media;
a first magnetic bias member and a second magnetic bias member each provided adjacent to the free layer, the first and second magnetic bias members being configured to have a first magnetisation direction which is substantially parallel to the reader edge;
an additional bias member disposed adjacent to the free layer, the additional bias member further being located proximal to at least one of the first magnetic bias member and the second magnetic bias member, and the additional bias member being configured to have a magnetisation direction that is substantially orthogonal to the first magnetisation direction.

2. The reader structure according to claim 1, comprising the additional bias member being in the form of a dual-polarity bias member that comprises at least a third magnetic bias component and a fourth magnetic bias component, the third magnetic bias component being located proximal to the first magnetic bias member and the fourth magnetic bias component being located proximal to the second magnetic bias member;
wherein the third and fourth magnetic bias components are configured to have alternate magnetisation directions, and further wherein the alternate magnetisation directions are substantially orthogonal to the first magnetisation direction.

3. The reader structure according to claim 1, wherein the additional bias member is disposed adjacent to the free layer at an opposite edge to the reader edge.

4. The reader structure according to claim 1, wherein the additional bias member is disposed adjacent to the free layer as a layer of the reader structure and said layer being in a plane passing through the free layer and the first magnetic bias member and the second magnetic bias member.

5. The reader structure according to claim 2, wherein the third and the fourth magnetic bias components are provided adjacent to each other.

6. The reader structure according to claim 2, wherein the magnetisation direction of the first magnetic bias member is orthogonally aligned to the magnetisation direction of the third magnetic bias component.

7. The reader structure according to claim 2, wherein the magnetisation direction of the second magnetic bias member is orthogonally aligned to the magnetisation direction of the fourth magnetic bias component.

8. A method of biasing a free layer of a reader structure that comprises a reader edge for interacting with and being proximal to a magnetic media, the method comprising,
providing a first magnetic bias member and a second magnetic bias member each adjacent to the free layer;
biasing a first magnetisation direction which is substantially parallel to the reader edge;
providing an additional bias member disposed adjacent to the free layer, the additional bias member being located proximal to at least one of the first magnetic bias member and the second magnetic bias member; and
biasing the additional bias member to have a magnetisation direction that is substantially orthogonal to the first magnetisation direction.

9. The method according to claim 8, wherein the additional bias member is provided in the form of a dual-polarity bias member that comprises at least a third magnetic bias component and a fourth magnetic bias component, the third magnetic bias component being located proximal to the first magnetic bias member and the fourth magnetic bias component being located proximal to the second magnetic bias member; and
wherein the third and fourth magnetic bias components are configured to have alternate magnetisation directions, and further wherein the alternate magnetisation directions are substantially orthogonal to the first magnetisation direction.

10. The method according to claim 8, wherein the additional bias member is disposed adjacent to the free layer at an opposite edge to the reader edge.

11. The method according to claim 8, wherein the additional bias member is disposed adjacent to the free layer as a layer of the reader structure and said layer being in a plane passing through the free layer and the first magnetic bias member and the second magnetic bias member.

12. The method according to claim 9, wherein the magnetisation direction of the first magnetic bias member is orthogonally aligned to the magnetisation direction of the third magnetic bias component.

13. The method according to claim 9, wherein the magnetisation direction of the second magnetic bias member is orthogonally aligned to the magnetisation direction of the fourth magnetic bias component.

14. The method according to claim 9, wherein the third and fourth magnetic bias components are located adjacent to each other.

15. A read head, the read head comprising,
a reader structure for reading magnetically recorded information, the reader structure comprising,
a free layer having a reader edge for interacting with and being proximal to a magnetic media;
a first magnetic bias member and a second magnetic bias member each provided adjacent to the free layer,
the first and second magnetic bias members being configured to have a first magnetisation direction which is substantially parallel to the reader edge;
an additional bias member disposed adjacent to the free layer, the additional bias member further being located proximal to at least one of the first magnetic bias member and the second magnetic bias member, and the additional bias member configured to have a magnetisation direction that is substantially orthogonal to the first magnetisation direction.

16. The read head according to claim 15, comprising the additional bias member being in the form of a dual-polarity bias member that comprises at least a third magnetic bias component and a fourth magnetic bias component, the third magnetic bias component being located proximal to the first magnetic bias member and the fourth magnetic bias component being located proximal to the second magnetic bias member;
wherein the third and fourth magnetic bias components are configured to have alternate magnetisation directions, and further wherein the alternate magnetisation directions are substantially orthogonal to the first magnetisation direction.
